(19) United States
(12) Patent Application Publication
(10) Pub. No.: US 2026/0106836 A1
(43) Pub. Date: Apr. 16, 2026

(54) Dynamic Unified Communications as a Service (UCaaS) application probing

(71) Applicant: Zscaler, Inc., San Jose, CA (US)

(72) Inventors: Ailin Saggau-Lyons, Vancouver (CA); Sandeep Kamath Voderbet, San Jose, CA (US); Surender Rammehar Singh, San Jose, CA (US); Chakkaravarthy Periyasamy Balaiah, San Jose, CA (US)

(73) Assignee: Zscaler, Inc., San Jose, CA (US)

(21) Appl. No.: 18/915,608

(22) Filed: Oct. 15, 2024

(51) Int. Cl. H04L 47/2483; H04L 67/50

(52) U.S. Cl. CPC H04L 47/2483; H04L 67/535

(57) ABSTRACT

Systems and methods for dynamic UCaaS application probing include monitoring, via the cloud-based system, one or more users associated with one or more tenants of the cloud-based system; detecting, based on the monitoring, one or more traffic flows that are associated with one or more Unified Communications as a Service (UCaaS) application calls; and sending a probe to one or more endpoints that are associated with the one or more UCaaS application calls. The steps further include collecting user experience data associated with the one or more UCaaS application calls and providing a unified dashboard for viewing the user experience data and troubleshooting any issues.

### FIELD OF THE DISCLOSURE

The present disclosure generally relates to network and cloud security. More particularly, the present disclosure relates to systems and methods for dynamic Unified Communications as a Service (UCaaS) application probing.

### BACKGROUND OF THE DISCLOSURE

Probing Unified Communications as a Service (UCaaS) applications to gather user experience data is essential for assessing the quality and performance of communication services. UCaaS platforms integrate voice, video, messaging, and collaboration tools into a single cloud-based solution, and the user experience in these apps plays a critical role in productivity and satisfaction. By analyzing the data collected through probing, service providers can identify potential bottlenecks or issues that impact performance. These insights enable them to optimize the app's infrastructure, improve reliability, and enhance the overall user experience. Moreover, continuous monitoring ensures proactive detection of issues before they affect end-users, thus maintaining high-quality communication services. Although, such traditional methods of probing are not useful when UCaaS applications connect to different datacenters for each call. Because of this, these traditional methods fail to accurately collect user experience data. Based thereon, the present disclosure provides systems and methods for dynamically probing UCaaS applications for determining associated endpoints and collecting user experience data.

### BRIEF SUMMARY OF THE DISCLOSURE

The present disclosure relates to systems and methods for dynamic UCaaS application probing. In various embodiments, the present disclosure includes a method having steps, a processing device configured to implement the steps, a cloud-based system configured to implement the steps, and as a non-transitory computer-readable medium storing instructions for programming one or more processors to execute the steps. The steps include monitoring, via the cloud-based system, one or more users associated with one or more tenants of the cloud-based system; detecting, based on the monitoring, one or more traffic flows that are associated with one or more Unified Communications as a Service (UCaaS) application calls; and sending a probe to one or more endpoints that are associated with the one or more UCaaS application calls.

The steps can further include performing pattern matching between the one or more traffic flows and one or more predefined UCaaS call patterns. The steps can further include generating one or more UCaaS call patterns based on historic log data. The monitoring can be performed with respect to one or more filters, wherein the one or more filters define what traffic flows are used in the detecting. The steps can further include responsive to sending a probe to the one or more endpoints, collecting user experience data associated with the one or more UCaaS application calls. The steps can further include utilizing an API associated with the one or more UCaaS applications to collect third party user experience data associated with the one or more UCaaS application calls. The steps can further include combining the third party user experience data and the user experience data collected via the probe; and providing a dashboard displaying the combined user experience data for any of the one or more UCaaS application calls. The steps can further include selecting one or more relevant active endpoints that should be probed based on the traffic flows and one or more predefined UCaaS call patterns. The detecting can include distinguishing between any of a Peer-to-Peer call, a UDP call, and a TCP call based on the traffic flows and one or more predefined UCaaS call patterns. The detecting can be based on one or more features of the traffic flows, the one or more features including any of port usage, number of active UCaaS application instances, number of active connections, and protocol usage.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a diagram of an exemplary network configuration illustrating an application on computing devices configured to operate through the cloud.

FIG. 5 is a flowchart of a process for dynamic UCaaS application probing.

### DETAILED DESCRIPTION OF THE DISCLOSURE

Again, the present disclosure relates to systems and methods for dynamic UCaaS application probing. As part of the ZDX service described herein, it is necessary to monitor network traffic associated with third party applications and observe network traffic patterns. Issues can arise when users utilize Unified Communications as a Service (UCaaS) applications such as Zoom, Teams, Webex, etc. as they may connect to different datacenters for each call. To solve these issues, the present disclosure provides a solution that, in various embodiments, includes monitoring the network traffic of third party applications and observing network traffic patterns to distinguish background activity from active usage (calls) and perform probing to associated servers based thereon. The UCaaS client is connected to several datacenters. The systems use further pattern matching to detect which of these datacenters is carrying the data for the active call and then runs synthetic ZDX probes to that datacenter for the duration of the call for collecting user experience data.

### § 1.0 CYBERSECURITY MONITORING AND PROTECTION EXAMPLES

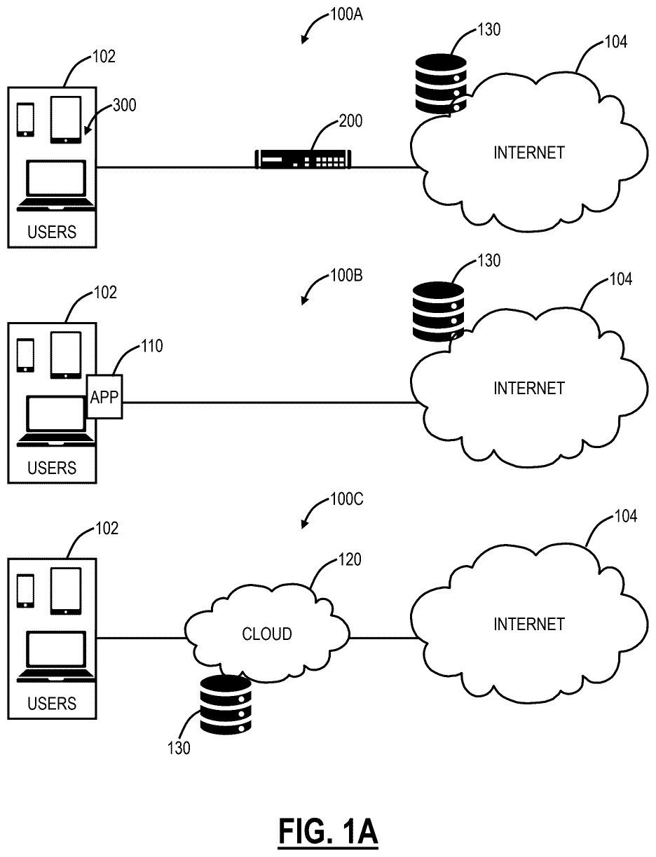

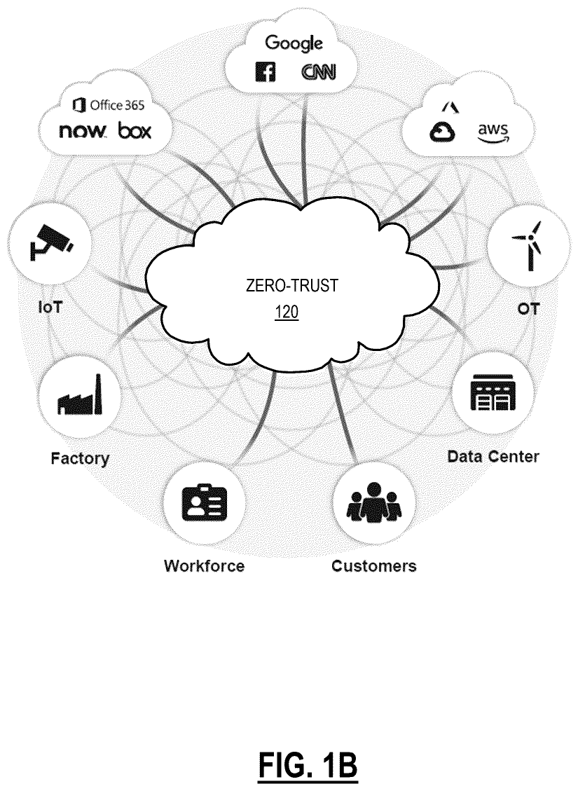

FIG. 1A is a network diagram of three example network configurations 100A, 100B, 100C of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

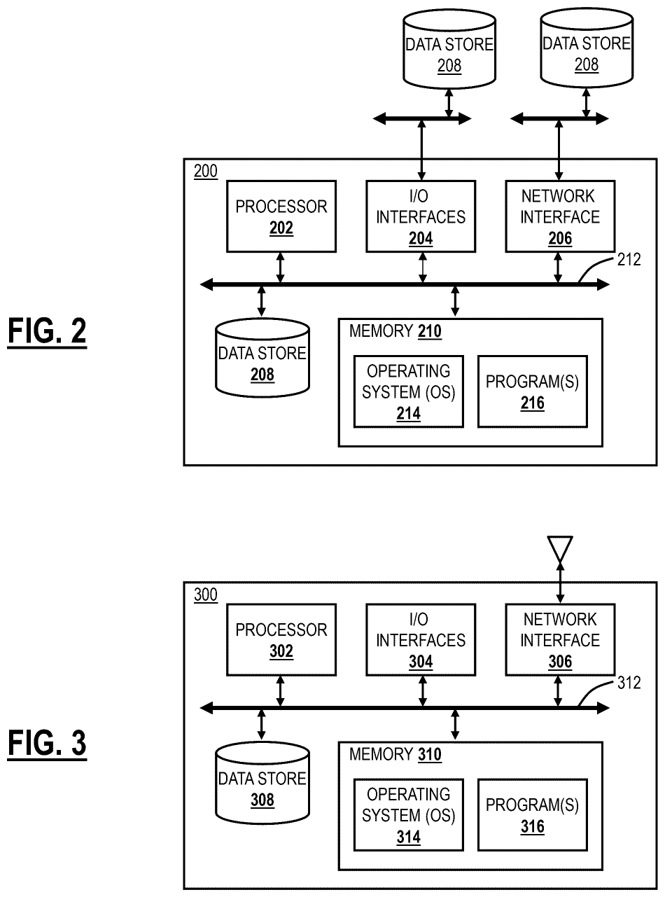

Note, the term endpoint 102 is used herein to refer to any computing device (see FIG. 3 for an example computing device 300) which can communicate on a network. The endpoint 102 can be associated with a user and include laptops, tablets, mobile phones, desktops, etc. Further, the endpoint can also mean machines, workloads, IoT devices, or simply anything associated with the company that connects to the Internet, a Local Area Network (LAN), etc.

As part of offering cybersecurity through these example network configurations 100A, 100B, 100C, there is a large amount of cybersecurity data obtained. Various embodiments of the present disclosure focus on using this cybersecurity data along with a customer's data to perform various security tasks including developing customer machine learning models and other security platforms of the like.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located inline with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 100C includes a cloud service 120 configured to monitor the endpoint 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 100C can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own endpoints 102 and configuration, policy, rules, etc.

### § 1.1 Cloud Monitoring

The cloud 120 can scale cybersecurity monitoring and protection with near-zero latency on the endpoints 102. Also, the cloud 120 in the network configuration 100C can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### § 1.2 Zero Trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication—not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:
Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time—before it reaches its destination—to prevent ransomware, malware, and more.
Protect data using granular context-based policies: Zero trust policies verify access requests and rights based on context, including user identity, device, location, type of content, and the application being requested. Policies are adaptive, so user access privileges are continually reassessed as context changes.
Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### § 1.3 Log Data

With the cloud 120 as well as any of the network configurations 100A, 100B, 100C, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

Also, such data is described in the following:

Commonly-assigned U.S. Pat. No. 8,429,111, issued Apr. 23, 2013, and entitled “Encoding and compression of statistical data,” the contents of which are incorporated herein by reference, describes compression techniques for storing such logs,

Commonly-assigned U.S. Pat. No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and

Commonly-assigned U.S. patent application Ser. No. 16/851,161, filed Apr. 17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 100C, as well as with other network configurations, the log data 130 is a rich repository of endpoint 102 activity. Unlike websites, specific cloud services, application providers, etc., cybersecurity monitoring can log almost all of a user's 102 activity. That is, the log data 130 is not merely confined to specific activity (e.g., a user's 102 social networking activity on a specific site, a user's 102 search requests on a specific search engine, etc.).

### § 2.0 EXAMPLE SERVER ARCHITECTURE

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc.

### § 3.0 EXAMPLE COMPUTING DEVICE ARCHITECTURE

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### § 4.0 APPLICATION FOR TRAFFIC FORWARDING AND MONITORING

Again, the network configuration 100B includes an application 110 that is executed on the computing device 300. The application 110 can perform similar functionality as the server 200, as well as coordinated functionality with the server 200 (a combination of the network configurations 100A, 100B). Of course, various embodiments are contemplated herein, including combinations of the network configurations 100A, 100B, 100C together. For example, the application 110 can perform similar functionality as the cloud 120, as well as coordinated functionality with the cloud 120.

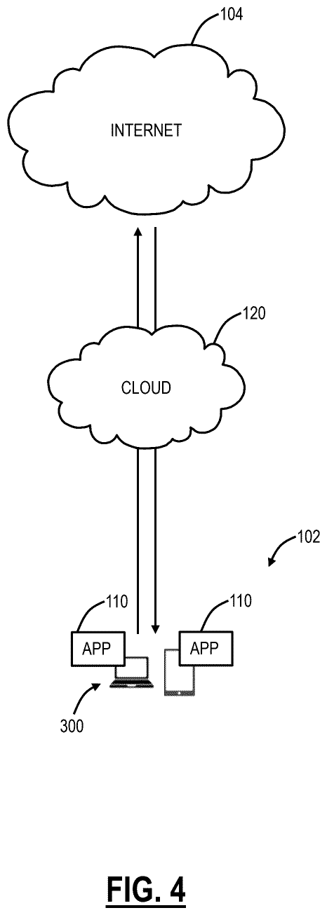

FIG. 4 is a network diagram of an exemplary network configuration illustrating an application 110 on computing devices 300 configured to operate through the cloud 120. Different types of computing devices 300 are proliferating, including Bring Your Own Device (BYOD) as well as IT-managed devices. The conventional approach for a computing device 300 to operate with the cloud 120 as well as for accessing enterprise resources includes complex policies, VPNs, poor user experience, etc. The application 110 can automatically forward user traffic with the cloud 120 as well as ensuring that security and access policies are enforced, regardless of device, location, operating system, or application. The application 110 automatically determines if a user 102 is looking to access the open Internet 104, a SaaS app, or an internal app running in public, private, or the datacenter and routes mobile traffic through the cloud 120. The application 110 can support various cloud services, including ZIA, ZPA, ZDX, etc., allowing the best in class security with zero trust access to internal applications. As described herein, the application 110 can also be referred to as a connector application.

The application 110 is configured to auto-route traffic for seamless user experience. This can be protocol as well as application-specific, and the application 110 can route traffic with a nearest or best fit node of the cloud 120. Further, the application 110 can detect trusted networks, allowed applications, etc. and support secure network access. The application 110 can also support the enrollment of the computing device 300 prior to accessing applications, the internet, or any services provided by the cloud 120. The application 110 can uniquely detect the users 102 based on fingerprinting the user device 300, using criteria like device model, platform, operating system, device posture, etc. The application 110 can support Mobile Device Management (MDM) functions, allowing IT personnel to deploy and manage the computing devices 300 seamlessly. This can also include the automatic installation of client and SSL certificates during enrollment. Finally, the application 110 provides visibility into device and app usage of the user 102 of the computing device 300.

The application 110 supports a secure, lightweight tunnel between the computing device 300 and the cloud 120. For example, the lightweight tunnel can be HTTP-based. With the application 110, there is no requirement for PAC files, an IPSec VPN, authentication cookies, or user 102 setup.

### § 5.0 DIGITAL EXPERIENCE MONITORING

The cloud-based system 120 provides security as a service and can also be used to provide real-time, continuous digital experience monitoring, as opposed to conventional approaches (synthetic probes). A key aspect of the architecture of the cloud-based system 120 is the inline monitoring. This means data is accessible in real-time for individual users from end-to-end. As described herein, digital experience monitoring can include monitoring, analyzing, and improving the digital user experience.

The cloud-based system 120 connects users 102 at the locations to various applications, the Internet 104, cloud services, etc. The inline, end-to-end visibility of all users enables digital experience monitoring. The cloud-based system 120 can monitor, diagnose, generate alerts, and perform remedial actions with respect to network endpoints, network components, network links, etc. The network endpoints can include servers, virtual machines, containers, storage systems, or anything with an IP address, including the Internet of Things (IoT), cloud, and wireless endpoints. With these components, these network endpoints can be monitored directly in combination with a network perspective. Thus, the cloud-based system 120 provides a unique architecture that can enable digital experience monitoring, network application monitoring, infrastructure component interactions, etc. Of note, these various monitoring aspects require no additional components—the cloud-based system 120 leverages the existing infrastructure to provide this service.

Again, digital experience monitoring includes the capture of data about how end-to-end application availability, latency, and quality appear to the end user from a network perspective. This is limited to the network traffic visibility and not within components, such as what application performance monitoring can accomplish. Networked application monitoring provides the speed and overall quality of networked application delivery to the user in support of key business activities. Infrastructure component interactions include a focus on infrastructure components as they interact via the network, as well as the network delivery of services or applications. This includes the ability to provide network path analytics.

The cloud-based system 120 can enable real-time performance and behaviors for troubleshooting in the current state of the environment, historical performance and behaviors to understand what occurred or what is trending over time, predictive behaviors by leveraging analytics technologies to distill and create actionable items from the large dataset collected across the various data sources, and the like. The cloud-based system 120 includes the ability to directly ingest any of the following data sources network device-generated health data, network device-generated traffic data, including flow-based data sources inclusive of NetFlow and IPFIX, raw network packet analysis to identify application types and performance characteristics, HTTP request metrics, etc. The cloud-based system 120 can operate at 10 gigabits (10 G) Ethernet and higher at full line rate and support a rate of 100,000 or more flows per second or higher.

The applications can include enterprise applications, Office 365, Salesforce, Skype, Google apps, internal applications, UCaaS applications, etc. These are critical business applications where user experience is important. The objective here is to collect various data points so that user experience can be quantified for a particular user, at a particular time, for purposes of analyzing the experience as well as improving the experience. In an embodiment, the monitored data can be from different categories, including application-related, network-related, device-related (also can be referred to as endpoint-related), protocol-related, etc. Data can be collected at the application 110 or the cloud edge to quantify user experience for specific applications, i.e., the application-related and device-related data. The cloud-based system 120 can further collect the network-related and the protocol-related data (e.g., Domain Name System (DNS) response time).

### Application-Related Data

| | |
|---|---|
| Page Load Time | Redirect count (#) |
| Page Response Time | Throughput (bps) |
| Document Object Model (DOM) Load Time | Total size (bytes) |
| Total Downloaded bytes | Page error count (#) |
| App availability (%) | Page element count by |
| | category (#) |

| | |
|---|---|
| HTTP Request metrics | Bandwidth |
| Server response time | Jitter |
| Ping packet loss (%) | Trace Route |
| Ping round trip | DNS lookup trace |
| Packet loss (%) | GRE/IPSec tunnel monitoring |
| Latency | MTU and bandwidth measurements |

| | |
|---|---|
| System details | Network (config) |
| Central Processing Unit (CPU) | Disk |
| Memory (RAM) | Processes |
| Network (interfaces) | Applications |

Metrics could be combined. For example, device health can be based on a combination of CPU, memory, etc. Network health could be a combination of Wi-Fi/LAN connection health, latency, etc. Application health could be a combination of response time, page loads, etc. The cloud-based system 120 can generate service health as a combination of CPU, memory, and the load time of the service while processing a user's request. The network health could be based on the number of network path(s), latency, packet loss, etc.

Lightweight connectors associated with the applications can also generate similar metrics for the applications. In an embodiment, the metrics can be collected while a user is accessing specific applications that user experience is desired for monitoring. In another embodiment, the metrics can be enriched by triggering synthetic measurements in the context of an inline transaction by the application 110 or cloud edge. The metrics can be tagged with metadata (user, time, app, etc.) and sent to a logging and analytics service for aggregation, analysis, and reporting. Further, network administrators can get UEX reports from the cloud-based system 120. Due to the inline nature and the fact the cloud-based system 120 is an overlay (in-between users and services/applications), the cloud-based system 120 enables the ability to capture user experience metric data continuously and to log such data historically. As such, a network administrator can have a long-term detailed view of the network and associated user experience.

### § 6.0 DYNAMIC UNIFIED COMMUNICATIONS AS A SERVICE (UCAAS) APPLICATION PROBING

As described herein, monitoring user experience is a key component of the cloud 120 for ensuring that its tenant's traffic is handled adequately. As part of the ZDX service described herein, it is necessary to monitor network traffic associated with third party applications and observe network traffic patterns. Issues can arise when users utilize Unified Communications as a Service (UCaaS) applications such as Zoom, Teams, Webex, etc. as they may connect to different datacenters for each call. To solve these issues, the present disclosure provides a solution that, in various embodiments, includes monitoring the network traffic of third party applications and observing network traffic patterns to distinguish background activity from active usage (calls) and perform probing to associated servers based thereon. The UCaaS client is connected to several datacenters. The systems use further pattern matching to detect which of these datacenters is carrying the data for the active call and then runs synthetic ZDX probes to that datacenter for the duration of the call for collecting user experience data.

This feature provides a new type of ZDX probe which is adapted to detect and probe endpoints dynamically rather than probing fixed endpoints at fixed intervals. Various embodiments of this feature include utilization of the application 110 on user computing devices 300. The digital experience service (ZDX) is adapted to leverage the present flow tracking to dynamically decide whether to run probes based on user activity. Thus, probes are only run for resources being used by the user.

Again, traditionally, digital experience probes are run even when an application is not in use. This is inefficient both for customer bandwidth and ZDX storage. Further, some applications have variable endpoints such as UCaaS calls. Since the systems don't know the endpoint ahead of time, systems send probes to application “front doors” instead of the currently used MMR. Even further, there are current gaps when mapping ZDX data to call quality information provided by public APIs from the UCaaS provider. Particularly, if a user has multiple devices/calls active at the same time. Based on these issues, the present disclosure provides systems and methods for only running probes for applications that are currently in use, dynamically identifying the endpoint and a probe to the detected destination, and detecting call quality issues from the flow tracking, user experience data, and active probing.

As described, the present systems and methods are adapted to perform measurements associated with third party calling applications in order to determine if they are running into issues. Again, typical user experience measurements are collected via periodic network probes to predefined locations. This can be done to measure latency, loading time, etc. of applications. In the case of UCaaS applications, every call typically goes to different data centers. In fact, a connectivity issue may occur during a call, and the application will switch to different data centers. Therefore, the present systems and methods are adapted to determine which data centers a call is going to while the call is running. This is performed by a network driver that monitors all network traffic associated with users. This driver specifically monitors these calling/UCaaS applications, and it tracks all the network traffic that these applications are associated with. This tracking can include tracking what ports they are connecting to, what destinations they are connecting to, how much data is flowing over these channels, etc. Thus, the systems track all of the traffic associated with these third party UCaaS applications.

Although, these UCaaS applications are also involved with non-call related traffic such as downloading updates and hosting chats. Therefore, the present systems are adapted to perform pattern matching on the network traffic to determine which connections are responsible for a call, and which of the connections are most likely going to be the ones that affect the call quality. It will be appreciated that the term “call” refers to a call performed via a UCaaS application such as a Zoom call for example. Based thereon, the system is adapted to dynamically go and probe those network connections and run probes to those specific servers. If the data center switches in the middle of the call the systems are adapted to hop over and start running probes to the next data center.

As stated, all traffic associated with UCaaS applications is monitored. Based on this traffic, various filters are utilized to determine what traffic is associated with calls, and what traffic is irrelevant. For example, irrelevant UCaaS traffic can be traffic that is associated with chats or application updates.

There are a large number of ways a call can be established. For example, there may be a connection up to some jump server or routing server where multiple users all connect to different or the same routing servers, where those servers are the backbone for transmitting the traffic back and forth. UCaaS applications typically have predefined port numbers that they use or have a specific host. For example, Zoom calls their servers Multi-Media Routers (MMRs). Thus, the systems can look at the hostnames and determine the traffic is not associated with an update server or a chat server. Similarly, the systems can look at the port numbers, the amount of data flowing, etc. to make such determinations.

These UCaaS applications have multiple methods for connecting to their servers. For instance, they may first attempt a UDP connection, and if that fails, they'll switch to a TCP connection. However, if two users on the same Wi-Fi network are in the same room, they won't connect to a server at all. Instead, they'll establish a direct connection between the users' devices. Based thereon significant research and development has been performed into understanding all the potential ways they could set up these connections. Based on this research and historic log data, a set of UCaaS call patterns are defined that positively identify any one of these possible ways of connecting a call and distinguish between them. Again, the present systems are also adapted to determine when a call has experienced a data canter switch and start probing to a new data center based thereon. Further, the driver can detect when a call has ended and cause the probing to stop until another call is detected.

The present monitoring processes leverage the information from flow tracking drivers to detect application activity and application endpoints for clients (standalone processes) at runtime. This is used for UCaaS applications to detect when a call is in progress as well as what destination/server the call data is being sent to. This is used to dynamically enable/disable MTR probes as well as select the endpoint for the probes at runtime. Information about the beginning and end of UCaaS calls also help distinguish which of a plurality of devices a call occurred on so the systems can map UCaaS Call Quality Monitoring (CQM) API data to probes data in the case where an end-user has multiple active devices.

The system is adapted to keep track of an application's active flows and apply pattern matching logic to detect a pattern that corresponds to a call and select relevant active endpoints that should be probed. This will improve probing logic to run only when user activity is detected and to dynamically select a specific endpoint of interest instead of running probes to a generic front door location. In order to implement the present UCaaS application monitoring, various embodiments include implementing one or more filters at various stages to determine if a flow is relevant. These filters can include filters to reduce the amount of inter-process messaging by dropping flows that aren't relevant for any application the present systems are monitoring. Various implementations perform this filtering based on the source application. Only flows originating from a monitored application pass this filter. Further, not all flows from an application are relevant for activity monitoring. For example, background traffic from a UCaaS application is not relevant for detecting call activity and does not need to be processed. Therefore, each flow arriving at the present UCaaS application monitoring system is passed through an individual filter of each active probe. Flows that pass the filter are passed to the probe for monitoring and the rest are dropped.

At this stage, only flows that are potentially useful for detecting activity are still being monitored. Each probe maintains lists of active flows, categorized by the Process ID (PID) of the process that initiated them. This is done to monitor the activity of multiple concurrent applications. For example, it is possible to be in two Zoom meetings at the same time, and these must be differentiated.

The systems must now consider a list of currently active flows and determine whether these amount to application activity. That is, the active flows can be matched to patterns that represent a call. For example, Zoom might be downloading an update which the systems shouldn't accidentally report as an ongoing call. Therefore, the systems need to look at all currently active flows and determine whether they amount to application activity and which type of multiple activity types they correspond to based on the patterns. A UCaaS application can have a Peer-to-Peer (P2P) call or a call that is proxied over servers. A proxied call could be running over UDP or over TCP depending on firewall and network constraints. Each call type can have various patterns that can be used to detect them. The patterns for a P2P, UDP & TCP call are very different so different pattern matching must be applied to detect each. These patterns can describe various features such as a number of connections, protocol used, number of application instances associated with the flow, etc. Various pattern examples are further described herein.

A single probe can contain multiple rules within its activity pattern, which are evaluated in a specific order. The first rule that matches the criteria is the one that gets reported. For instance, a UDP call might involve three or more UDP connections originating from the same UCaaS process and directed to the same endpoint using specific port numbers. In contrast, a peer-to-peer (P2P) call could involve similar UDP traffic but without the use of those specific port numbers. By enforcing a rule order, the system can distinguish between a UDP call and a P2P call, ensuring the correct identification of the traffic type based on the relevant criteria.

When an application is found to be active, multiple flows/endpoints might have matched a pattern. In this case the systems need to select which one (or more) flows to report in the next callback notification. This will determine which endpoint(s) a trace probe should be run to. For example, a Zoom call might have control and data channels extending to different endpoints. The trace performed by the system might want to follow the data channels. The system is adapted to run the flows that matched for activity through one additional set of filters. Flows that matched one or more of the filters are added to the list of flows returned by a callback. For example, incoming and outgoing data might point to different endpoints in which case the system may want to run multiple traces.

As described, a key component of the present systems includes a driver for flow tracking. The driver is adapted to support system wide tracking, track flows for TCP, UDP, and ICMP Echo Request/Response, start/stop on demand, and support filters to include and exclude traffic as described. The driver, and the systems described herein, can be facilitated in the cloud 120 for determining UCaaS application calls and collecting user experience data for tenants of the cloud 120. The driver can be adapted to generate events for network flows including flow start, flow end, and periodic flow notifications describing the current state of the flow (bytes sent/bytes received so far) which can be reported periodically based on the configuration. Interval specified for periodic notification. The periodic flow notifications take place only during an activity on the flow e.g. outbound or inbound activity on the flow.

The various predefined UCaaS call patterns that are used to determine if a call is taking place are based on various features. Based thereon, the driver is adapted to collect information associated with flow events. This information can include the following.
Event Type—Flow Start, Flow End, Flow Intermediate/periodic notification etc.
Protocol—TCP, UDP or ICMP
Address Family—IPv4 or IPv6
Local Address and Port
Remote Address and Port
ICMP Identifier and Sequence Number
FQDN for TCP connection to port 80 and 443
Start Time
Event time—This can be the flow end time or time of a periodic flow notification
Bytes Sent—Number of bytes sent. Bytes Sent includes the sizes of IP Header, Transport Header and Application Data. For outbound traffic, the packet indication contains only Transport Header and Application Data. Hence, a fixed IP Header size is used for the packet length calculation. The data size excludes any packet encapsulation e.g. IPSec.
Bytes Received—Number of bytes received. Bytes Received includes the sizes of IP Header, Transport Header and application data. For inbound traffic, the packet indication contains IP Header, Transport Header, and Application Data. The data size excludes any packet encapsulation e.g. IPSec.
Process ID
Application Full Path
User SID
Number of active application instances
Number of connections

The various filters described herein allow the driver to be customized to control what network flows should be tracked.

The purpose of determining and probing these specific data centers/servers after detecting a call is to collect user experience data. This data is then utilized as described herein for determining if, for example, a user is having trouble connecting, is there a high latency, is there a high packet loss, etc. Based on this premise, the systems can further utilize APIs associated with the UCaaS applications to collect further user experience data to add to the user experience data collected via the dynamic probing. Finally, the systems can provide a unified dashboard that displays all of the collected information including the API collected user experience data as well as the user experience data collected from the dynamic probing.

As described different patterns are used to determine if traffic flows are associated with UCaaS calls. The following represents various example patterns that the system can utilize for determining a call is taking place.

### Peer-to-Peer (P2P) Call:

For example, a Zoom P2P call occurs when two devices connect directly to each other and send data to each other without a datacenter in the middle. A Zoom P2P call can be detected based on the following patterns:

When a single instance of the zoom.exe application makes at least 2 connections and the call has not already been classified as a Zoom UDP or Zoom TCP call.

One or more TCP connections (the control channels) going to a Zoom datacenter with a hostname matching the regular expression .*mmr\\.(.*)\\.zoom.us and destination port 443.

One or more UDP connections (the data channels) using any destination port other than 8801, 8802 8803, 3478, 4379.

If at least one control and at least one data channel are detected then the system will probe the data channel carrying the most data (received bytes+sent bytes).

### TCP Call:

A Webex TCP call occurs when the Webex application connects a call where the data channel uses TCP. This typically occurs when UDP connections are blocked by the firewall.

A Webex TPC call can be detected when:

A single instance of either atmgr.exe or ciscocollabhost.exe establish at least 3 concurrent connections to the same destination where the ports used are 443, 5004, or 9000 and the client hello did not contain an SNI during the TLS handshake

If at least 3 concurrent connections matching this rule are seen and the flows were not already identified as a Webex UDP call the system will probe the channel carrying the most traffic (received bytes+sent bytes).

### UDP/P2P Call:

A Teams UDP/P2P call occurs when:

A single instance of either the teams.exe or ms-teams.exe client establish at least 2 concurrent UDP connections to some port other than 443.

If at least 2 concurrent connections are seen the system will probe the one carrying the most traffic (received bytes+sent bytes).

A Teams UDP or P2P use the same rule for simplicity but can be distinguished if required. In the case of a UDP call, this rule will identify the teams datacenter and probe it. In the case of a P2P call, it will identify the peers' machine on the same local network and probe it.

It will be appreciated that the present processes for detecting UCaaS destination servers and probing to collect user experience data is one example of the implementation of the present systems. That is, the present systems can be utilized to identify arbitrary network traffic patterns on endpoint clients involving filters around applications while tracking process names, process ids, and each unique processes connections involving destination IP and port, source IP and port, sent and received bytes, protocol, hostname, connection duration, etc.

### § 6.1 Dynamic UCaaS Application Probing Process

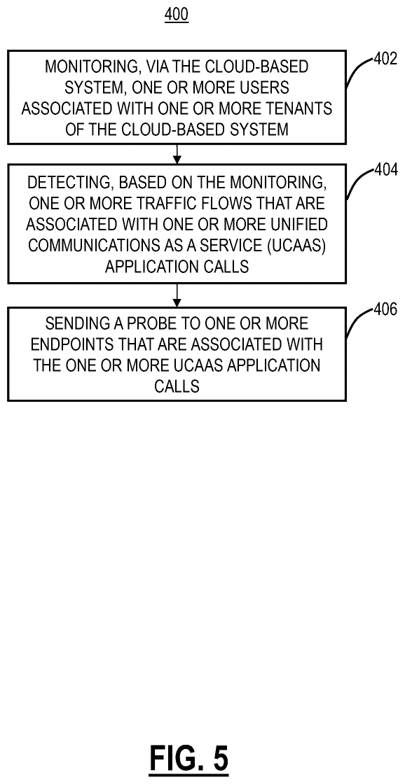

FIG. 5 is a flowchart of a process 400 for dynamic UCaaS application probing. In various embodiments, the process 400 can be contemplated as a method having steps, a processing device configured to implement the steps, a cloud-based system configured to implement the steps, and as a non-transitory computer-readable medium storing instructions for programming one or more processors to execute the steps. The process 400 includes monitoring, via the cloud-based system, one or more users associated with one or more tenants of the cloud-based system (step 402); detecting, based on the monitoring, one or more traffic flows that are associated with one or more Unified Communications as a Service (UCaaS) application calls (step 404); and sending a probe to one or more endpoints that are associated with the one or more UCaaS application calls (step 406).

The process 400 can further include performing pattern matching between the one or more traffic flows and one or more predefined UCaaS call patterns. The steps can further include generating one or more UCaaS call patterns based on historic log data. The monitoring can be performed with respect to one or more filters, wherein the one or more filters define what traffic flows are used in the detecting. The steps can further include responsive to sending a probe to the one or more endpoints, collecting user experience data associated with the one or more UCaaS application calls. The steps can further include utilizing an API associated with the one or more UCaaS applications to collect third party user experience data associated with the one or more UCaaS application calls. The steps can further include combining the third party user experience data and the user experience data collected via the probe; and providing a dashboard displaying the combined user experience data for any of the one or more UCaaS application calls. The steps can further include selecting one or more relevant active endpoints that should be probed based on the traffic flows and one or more predefined UCaaS call patterns. The detecting can include distinguishing between any of a Peer-to-Peer call, a UDP call, and a TCP call based on the traffic flows and one or more predefined UCaaS call patterns. The detecting can be based on one or more features of the traffic flows, the one or more features including any of port usage, number of active UCaaS application instances, number of active connections, and protocol usage.

### § 7.0 CONCLUSION

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. Additionally, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

What is claimed is:

1. A method implemented by a cloud-based system, the method comprising steps of:
monitoring, via the cloud-based system, one or more users associated with one or more tenants of the cloud-based system;
detecting, based on the monitoring, one or more traffic flows that are associated with one or more Unified Communications as a Service (UCaaS) application calls; and
sending a probe to one or more endpoints that are associated with the one or more UCaaS application calls.

2. The method of claim 1, wherein the detecting comprises performing pattern matching between the one or more traffic flows and one or more predefined UCaaS call patterns.

3. The method of claim 2, wherein the steps comprise:
generating one or more UCaaS call patterns based on historic log data.

4. The method of claim 1, wherein the monitoring is performed with respect to one or more filters, and wherein the one or more filters define what traffic flows are used in the detecting.

5. The method of claim 1, wherein the steps further comprise:
responsive to sending a probe to the one or more endpoints, collecting user experience data associated with the one or more UCaaS application calls.

6. The method of claim 5, wherein the steps further comprise:
utilizing an API associated with the one or more UCaaS applications to collect third party user experience data associated with the one or more UCaaS application calls.

7. The method of claim 6, wherein the steps further comprise:
combining the third party user experience data and the user experience data collected via the probe; and
providing a dashboard displaying the combined user experience data for any of the one or more UCaaS application calls.

8. The method of claim 1, wherein the steps comprise:
selecting one or more relevant active endpoints that should be probed based on the traffic flows and one or more predefined UCaaS call patterns.

9. The method of claim 1, wherein the detecting comprises distinguishing between any of a Peer-to-Peer call, a UDP call, and a TCP call based on the traffic flows and one or more predefined UCaaS call patterns.

10. The method of claim 1, wherein the detecting is based on one or more features of the traffic flows, the one or more features including any of port usage, number of active UCaaS application instances, number of active connections, and protocol usage.

11. A non-transitory computer-readable medium comprising instructions that, when executed, cause one or more processors associated with a cloud-based system to perform steps of:
monitoring, via the cloud-based system, one or more users associated with one or more tenants of the cloud-based system;
detecting, based on the monitoring, one or more traffic flows that are associated with one or more Unified Communications as a Service (UCaaS) application calls; and
sending a probe to one or more endpoints that are associated with the one or more UCaaS application calls.

12. The non-transitory computer-readable medium of claim 11, wherein the detecting comprises performing pattern matching between the one or more traffic flows and one or more predefined UCaaS call patterns.

13. The non-transitory computer-readable medium of claim 12, wherein the steps comprise:
generating one or more UCaaS call patterns based on historic log data.

14. The non-transitory computer-readable medium of claim 11, wherein the monitoring is performed with respect to one or more filters, and wherein the one or more filters define what traffic flows are used in the detecting.

15. The non-transitory computer-readable medium of claim 11, wherein the steps further comprise:
responsive to sending a probe to the one or more endpoints, collecting user experience data associated with the one or more UCaaS application calls.

16. The non-transitory computer-readable medium of claim 15, wherein the steps further comprise:
utilizing an API associated with the one or more UCaaS applications to collect third party user experience data associated with the one or more UCaaS application calls.

17. The non-transitory computer-readable medium of claim 16, wherein the steps further comprise:
combining the third party user experience data and the user experience data collected via the probe; and
providing a dashboard displaying the combined user experience data for any of the one or more UCaaS application calls.

18. The non-transitory computer-readable medium of claim 11, wherein the steps comprise:
selecting one or more relevant active endpoints that should be probed based on the traffic flows and one or more predefined UCaaS call patterns.

19. The non-transitory computer-readable medium of claim 11, wherein the detecting comprises distinguishing between any of a Peer-to-Peer call, a UDP call, and a TCP call based on the traffic flows and one or more predefined UCaaS call patterns.

20. The non-transitory computer-readable medium of claim 11, wherein the detecting is based on one or more features of the traffic flows, the one or more features including any of port usage, number of active UCaaS application instances, number of active connections, and protocol usage.
